(19) United States
(12) Patent Application Publication
(10) Pub. No.: US 2023/0153690 A1
(43) Pub. Date: May 18, 2023

(54) SELF-SUPERVISED THREE-DIMENSIONAL LOCATION PREDICTION USING MACHINE LEARNING MODELS

(71) Applicant: QUALCOMM Incorporated, San Diego, CA (US)

(72) Inventors: Hanno ACKERMANN, Hilversum (NL); Ilia KARMANOV, Amsterdm (NL); Farhad GHAZVINIAN ZANJANI, Almere (NL); Daniel Hendricus Franciscus DIJKMAN, Haarlem (NL); Fatih Murat PORIKLI, San Diego, CA (US)

(21) Appl. No.: 18/047,796

(22) Filed: Oct. 19, 2022

Related U.S. Application Data
(60) Provisional application No. 63/264,146, filed on Nov. 16, 2021.

(51) Int. Cl. G06N 20/00

(52) U.S. Cl. CPC G06N 20/00

(57) ABSTRACT

Certain aspects of the present disclosure provide techniques method for self-supervised training of a machine learning model to predict the location of a device in a spatial environment, such as a spatial environment including multiple discrete planes. An example method generally includes receiving an input data set of scene data. A generator model is trained to map scene data in the input data set to points in three-dimensional space. One or more critic models are trained to backpropagate a gradient to the generator model to push the points in the three-dimensional space to one of a plurality of planes in the three-dimensional space. At least the generator is deployed.

### CROSS-REFERENCE TO RELATED APPLICATIONS

This application claims the benefit of and priority to U.S. Provisional Patent Application Ser. No. 63/264,146, entitled “Self-Supervised Three-Dimensional Location Prediction Using Machine Learning Models,” filed Nov. 16, 2021, and assigned to the assignee hereof, the contents of which are hereby incorporated by reference in its entirety.

### INTRODUCTION

Aspects of the present disclosure relate to using machine learning to estimate the location of a device or object in a three-dimensional environment.

Location estimation may be used in a variety of applications. For example, devices may use three-dimensional ego-localization techniques for location estimation may allow a device to determine its own location in a spatial environment from a first-person view (e.g., from the perspective of the device itself). Three-dimensional ego-localization may also allow for the determination of a location of an object in a three-dimensional space from a third-person view (e.g., a view through which the object is observed) In another example, location estimation may be performed to identify a location of an object passing through an environment, such as identifying the location of a person causing a perturbation to a wireless signal as the person walks through an environment. Various types of data may be used in location estimation in order to determine (or predict) the location of a device in the spatial environment. For example, information derived from wireless channel measurements may be used to predict the location of the device, and the resulting location estimate can be used to aid in identifying various parameters for subsequent transmissions in the wireless communications system, such as one or more directional beams to use in communicating between a network entity, such as a base station, and a user equipment, to identify beamforming patterns to apply to allow for directionality in signal processing, and the like. In another example, a series of images can be used to predict the location of the device in a three-dimensional space.

Various techniques can be used for location estimation in spatial environments. For example, various machine learning models trained using supervised learning techniques using labeled data can be used for location estimation. Other models may use a defined three-dimensional model of the spatial environment to estimate the location of a device in a spatial environment. In another example, simultaneous localization and mapping (SLAM) techniques can be used to simultaneously build a map of the spatial environment and estimate the location of a device. Generally, these models may need an input including label data that may not be known. Further, these models may be limited to data in the visual domain (e.g., in data in the visible spectrum between 480 nm and 720 nm or in other spectra from which an image can be generated) and may not account for data from other modalities that can enhance visual data and illustrate additional details in the spatial environment that may be unknown in the visual domain.

### BRIEF SUMMARY

Certain embodiments provide a method for self-supervised training of a machine learning model to predict the location of a device in a spatial environment. An example method generally includes receiving an input data set of scene data. A generator model is trained to map scene data in the input data set to points in one or more multidimensional spaces. One or more critic models backpropagate a gradient to the generator model to push the points in the one or more multidimensional spaces to one of a plurality of planes in the one or more multidimensional spaces. At least the generator model is deployed.

Certain embodiments provide a method for predicting a location of a device in a spatial environment using a self-supervised machine learning model. An example method generally includes receiving scene data. The scene data is mapped to one or more points in one or more multidimensional spaces through a generator model. The generator model may have a loss term backpropagated to the generator model from one or more critic models configured to separate points in the one or more multidimensional spaces into one of a plurality of planes such that the points in the one or more multidimensional spaces are in a vicinity of any of the plurality of planes in one or more multidimensional spaces.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example environment in which perturbation to electromagnetic waves can be used to predict a location of a device.

FIG. 2 depicts an example environment in which spatial data is located on multiple planes in a three-dimensional space.

FIG. 3 depicts an example architecture of a self-supervised location prediction model configured to predict the location of a device on one of a plurality of planes in a multidimensional space, according to aspects of the present disclosure.

FIG. 4 depicts an example selection of an inlier threshold for identifying points on a plane in a three-dimensional space based on a line search, according to aspects of the present disclosure.

FIG. 5 depicts example selection of an inlier threshold for identifying points on a plane in a three-dimensional space based on point density, according to aspects of the present disclosure.

FIG. 6 depicts example operations for training a self-supervised location prediction model to predict a location of a device on one of a plurality of planes in a three-dimensional space, according to aspects of the present disclosure.

FIG. 7 depicts operations for predicting a location of a device on one of a plurality of planes in a three-dimensional space using a self-supervised location prediction model, according to aspects of the present disclosure.

FIG. 8 depicts an example implementation of a processing system on which a self-supervised location prediction model is trained to predict a location of a device on one of a plurality of planes in a three-dimensional space, according to aspects of the present disclosure.

FIG. 9 depicts an example implementation of a processing system on which a self-supervised location prediction model is used to predict a location of a device on one of a plurality of planes in a three-dimensional space, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide techniques for predicting a location of a device or object on one of a plurality of planes a three-dimensional space using machine learning models.

Location estimation may be used to estimate the location of a different device (also known as third-person localization) or the location of the device itself (also known as ego-localization) within a spatial environment. Because location estimation may allow for the estimation of the location of a device, location estimation may have many uses. For example, location estimation may be a powerful tool to aid in identifying parameters to use in wireless communications. In such a base, location estimation may allow for beamforming or beam selection to be performed in such a manner that maximizes the strength of signaling received by a device in a wireless communication system (e.g., a UE).

Various techniques may be used in location estimation, such as triangulation or fingerprinting based on features that correlate with the location of a device. However, triangulation may impose a coordination overhead for transmitting devices in a wireless communication system, and fingerprinting may be specific to a particular environment (e.g., an open field, a suburban area, an urban area, a room, etc.). In another example, location estimation may allow for mapping of a three-dimensional environment through various types of scene data, such as a series of images, channel state information measurements, and the like.

In many environments, a three-dimensional space may be divided into different planes. For example, in a building, different planes may correspond to different floors of the building (e.g., a first plane for the ground floor, a second plane above the first plane for a second floor of the building (e.g., the first floor above the ground floor), a third plane above the second plane for a third floor of the building (e.g., the second floor above the ground floor), and the like). To predict which plane (or floor) scene data retrieved from a device is located, various models can be used. These models may be trained using supervised techniques. For example, in geo-localization models, the images may be tagged with geospatial coordinates associated with locations at which the images were captured. In another example, camera localization models, which can perform six-dimensional pose estimation based on a three-dimensional location and a three-axis orientation of a camera, can be trained using supervised learning techniques based on a three-dimensional model of the environment in which images were captured. In still another example, simultaneous localization and mapping (SLAM) may allow for unsupervised or supervised learning, but may be limited to image data, which may limit the amount of data that can be used to train a model to predict device location in a three-dimensional environment. However, these models may need a significant amount of data for training and may be limited to the specific environments in which these models are trained (e.g., may not be generalizable to unseen three-dimensional environments).

Aspects of the present disclosure provide techniques that allow for self-supervision of machine learning models to predict the location of devices or objects in three-dimensional environments. Generally, the predicted location of devices may include a predicted plane (from a plurality of potential planes) in which a device is located, which may allow for three-dimensional location estimation in environments including multiple stories or other surfaces having varying height components. As discussed in further detail herein, the machine learning models may be trained to predict a location of a device in a three-dimensional space, including the location of the device on one of a plurality of planes, based on various types of scene data, such as visual data (e.g., data in the visual spectrum between 480 nm and 720 nm) or data from other modalities, such as data generated from measurements in a wireless communication network (e.g., channel state information (CSI) measurements in a wireless network) that may be useful in identifying a position of a device (e.g., relative to other transmitting devices in a spatial environment).

By training and using a self-supervised machine learning model to predict the location of a device in a spatial environment, aspects of the present disclosure may allow for a machine learning model to accurately predict device location in a three-dimensional environment including multiple planes (e.g., multiple stories or height components). Relative to supervised learning techniques, a smaller data set may be needed to train the self-supervised machine learning model, as the self-supervised machine learning model may not need explicitly labeled data (which may not exist), for example, in cases where a wireless device is aware that the device or a person is traveling on a plane generally, but is unaware of which plane of a plurality of planes the device is traveling. This may allow for models to be trained and used to predict the location of a device in a spatial environment in the absence of label information for spatial training data, and may also reduce computational resource usage for predicting the location of a device or object in an environment with multiple planes, such as multi-story buildings or the like.

### Example Environments for Location Estimation

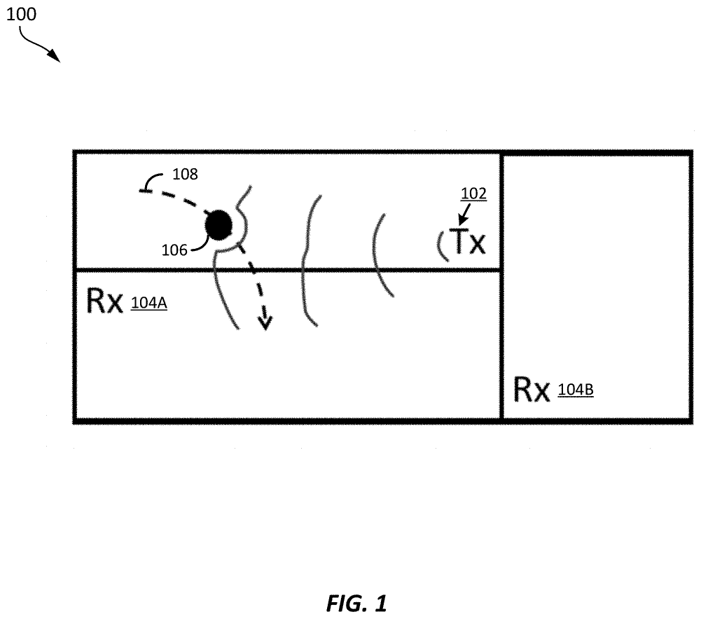

FIG. 1 illustrates an example multi-room, multi-planar environment 100 in which the perturbation of electromagnetic waves can be used to predict a location of a device. As illustrated, the multi-planar environment 100 may include a transmitter device (Tx) 102 and one or more receiver devices (Rx) 104A-104B. As illustrated, the transmitter device 102 may be located on a first floor (e.g., a first plane in the multi-planar environment), while another receiver device may be located on a different floor (e.g., a second plane in the multi-planar environment), and the transmitter device 102 can emit electromagnetic waves towards a receiver device 104A. While the transmitter device 102 emits electromagnetic waves towards the receiver device 104A, an object 106 may move along a path 108. As the object 106 moves along the path 108, the electromagnetic waves transmitted by the transmitter device 102 may be perturbed, or disrupted due to reflection and/or absorption of electromagnetic waves, by the object 106. The disruption may result in a difference in a signal quality measurement (e.g., channel state information (CSI), reference signal received power (RSRP), etc.) relative to a previous time in which the object 106 did not perturb the electromagnetic waves.

Thus, within the environment 100, movement in the environment can be modeled based on movement of the object 106 and the channel state information (or other signal quality measurement) changes experienced while the object 106 follows the path 108 through the environment 100. To model movement within the environment 100, channel state measurements may be performed over a period of time, and over a plurality of subcarriers in a wireless network. A resulting map of power density (or other received signal strength measurements such as channel state information) over a plurality of subcarriers and over a period of time may show a path of movement as a divergence in a graphical representation of the power density information over time for the subcarriers in a wireless network. This divergence, for example, may include a change in measurements or other changes in the information in the power density map may show movement over time based on the perturbed subcarriers in the environment 100 evidenced through changes in a measured channel reflected in the power density map.

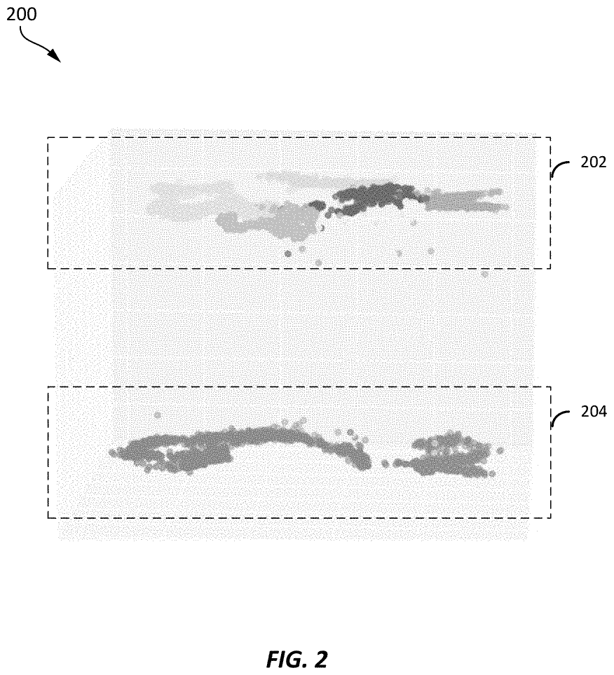

FIG. 2 illustrates an example environment 200 in which spatial data is located on multiple planes in a three-dimensional space. As illustrated, the environment 200 may be divided into a first plane 202, corresponding to a first floor in a multi-floor environment, and a second plane 204, corresponding to a second floor in the multi-floor environment. For example, the first plane 202 may correspond to the floor on which the transmitting device 102 illustrated in FIG. 1 is located, and the second plane 204 may correspond to the floor on which the receiving devices 104A and 104B are located. The bulk of the predicted position points in the plot illustrating the example environment 200 may largely be located in their respective planes, representing motion captured on a floor in the multi-floor environment. A transition from the first plane 202 to the second plane 204, or vice versa, may be captured by a number of points between first plane 202 and second plane 204.

Various techniques can be used to generate the plot for the environment 200 illustrated in FIG. 2. For example, indoor positioning may be performed using passive wireless sensing on real data. In this example, information about the z coordinate plane may need to be known, along with information about a specific room in which a user was located when channel state information was measured and transmitted to one or more devices for use. Further, to effectuate a mapping of the environment 200, a floor plan for the building or other built environment in from which data was captured may be needed to classify user samples into the specific room in which the data was captured. Generally, these models may receive as input coordinates in one or more planes (e.g., the x and y axes within a graph). Information about the floor plan of the environment in which the device is operating, and the like, and x and y coordinates may be needed as input in order to train a model to predict a location in a three-dimensional environment.

In another example, active sensing can be used to generate the plot for the environment 200 illustrated in FIG. 2. In active sensing, a device attempting to discover its location within a spatial environment can actively transmit and receive radio frequency signals. The device can extract information from the radio frequency signals in the environment, such as channel state information, time of flight, angle of arrival, and the like. Based on the extracted information, the device can learn its position relative to other wireless devices in the spatial environment.

Further, as discussed, various other techniques can be used to generate the plot for the environment 200 illustrated in FIG. 2. However, as discussed, these techniques may each entail training a model based on supervised data and may have a limited capability to learn from data outside of the visual domain. While training a data set based on labeled data may allow for the creation of a powerful model that is able to differentiate between planes in a three-dimensional space, such a model may be limited to a specific environment, which may not be readily accessible and for which data, such as images captured by a camera of a mobile device, video content, and the like, may not be usable in various inference operations. Further, such data may not actually exist; that is, a device may be able to locate itself on the x and y planes (lateral and depth motion), but may not be able to identify the z axis, and thus the corresponding plane (e.g., floor of a building), on which the data is located.

### Example Self-Supervised Learning for Models for Predicting Device Location on Planes in a Spatial Environment

As discussed, positioning data in the real world may be located in a three-dimensional space, including an x axis (lateral movement), y axis (depth movement), and a z axis (vertical movement). Generally, with the exception of occasions in which a user is transitioning from one floor to another floor in a building, movement on any given plane may remain on that plane until a transition is made from one plane (e.g., a floor in a building) to a different plane (e.g., a different floor in the building).

In some cases, a fully supervised model, which may be trained using position information tagged with information identifying a plane on which the position information is located, may allow for device location predictions to be easily made. However, without knowing which points are located on a specific plane in a multi-planar environment or how many points are located on specific planes, it may be difficult to train and use a machine learning model to make such predictions.

To leverage the fact that position information in a three-dimensional environment including a plurality of floors may generally be located on one of a plurality of planes, various techniques can be used to encourage co-planarity of the data points in the environment 100 and allow for data points to be associated, for example, with different planes in a three-dimensional environment. These techniques may generally include various reinforcement learning models or adversarial networks. For example, given a transformation of input scene data, such as channel state information maps (or power density maps) captured by a device or images (or portions of images), a transformer model can map these scenes to a predicted space in a three-dimensional model. A loss signal, fed back to other neural networks, may be used to attract co-planar data to a same plane in the three-dimensional space and repel non-co-planar data to different planes in the three-dimensional space. As discussed, however, many techniques for identifying a plane from a plurality of planes may entail some form of supervised learning, in which data that is unknown and potentially unknowable is provided as input into a model. For example, some models may use data in the x, y, and z axes, but the scene data captured by a device may not have any coordinates in the z axis because there may be no easy, computationally inexpensive, manner by which the coordinates in the z axis for a given captured object may be learned.

In generative adversarial learning, two neural networks may be used to generate inferences. Generally, an agent neural network is trained to map an input of spatial data into a latent space encoding. This latent space encoding may then be provided to a discriminator, which may be used to determine whether the data is training data or non-training data and can backpropagate a loss to an agent neural network. Generally, the agent neural network and the discriminator model are adversarial, and during training, the agent may continually learn to attempt to fool the discriminator into believing that the latent space encoding of scene data corresponds to ground truth data, not data generated by the agent neural network.

In another example, imitation learning can be used to train a model to predict a location of an object in an environment including one or more planes. A discriminator of a generative adversarial imitation learning system may be replaced by one or more self-supervised critic models. The self-supervised critic models can determine how well the generator is generating points in a multidimensional space and may provide a signal for training the generator to accurately produce data in the multidimensional space. For example, as discussed in further detail below, the generator may map an input into a three-dimensional space and a 128-dimensional space, and the critic models can evaluate how well the inputs are mapped into these spaces and feed a signal (e.g., backpropagate a gradient) to the generator. In some aspects, one or more of the self-supervised critic models may be configured to count a number of points on a plane in order to identify the boundaries of different regions (e.g., planes) in a multidimensional space.

While generative adversarial learning and imitation learning alone may be used to predict the location of an object in an environment including one or more planes, the training data may need to include three-dimensional location data which may not be available or easily captured by a device on which location estimation is performed. To allow for a model to be trained based on a training data set of scene data that may not include state data paired with associated location data in a multidimensional space, aspects of the present disclosure may leverage generative adversarial imitation learning to allow for self-supervised multidimensional location estimation (e.g., ego localization, third-person localization, object location, etc.) using a self-supervised location prediction model. These machine learning models may include a generator and a discriminator that work in conjunction to predict the location of an object in a spatial environment.

As discussed in further detail below, the generator in the self-supervised location prediction model may produce outputs of points in a one or more multidimensional spaces (e.g., a three-dimensional space and a 128-dimensional space) at which scene data inputs exist, and a discriminator (or critic) in the self-supervised location prediction model distinguishes between the outputs of the generator and known training data. Because a training data set of scene data may not include pairs of states with an associated location in a multidimensional space, a discriminator model in a typical generative adversarial network may be replaced by one or more critic models that learn a value function from a signal (e.g., associated with a distance between a point in the one or more multidimensional spaces and a plane in the one or more multidimensional spaces). Meanwhile, the generator learns to map scene data inputs to points in the one or more multidimensional spaces. Generally, the generator may be trained to produce co-planar locations (e.g., locations on a same plane in a multidimensional space). However, to allow for unsupervised and self-supervised learning, the generator may be unaware of the number of planes in a scene or which points in a multidimensional space belong with which plane in the scene.

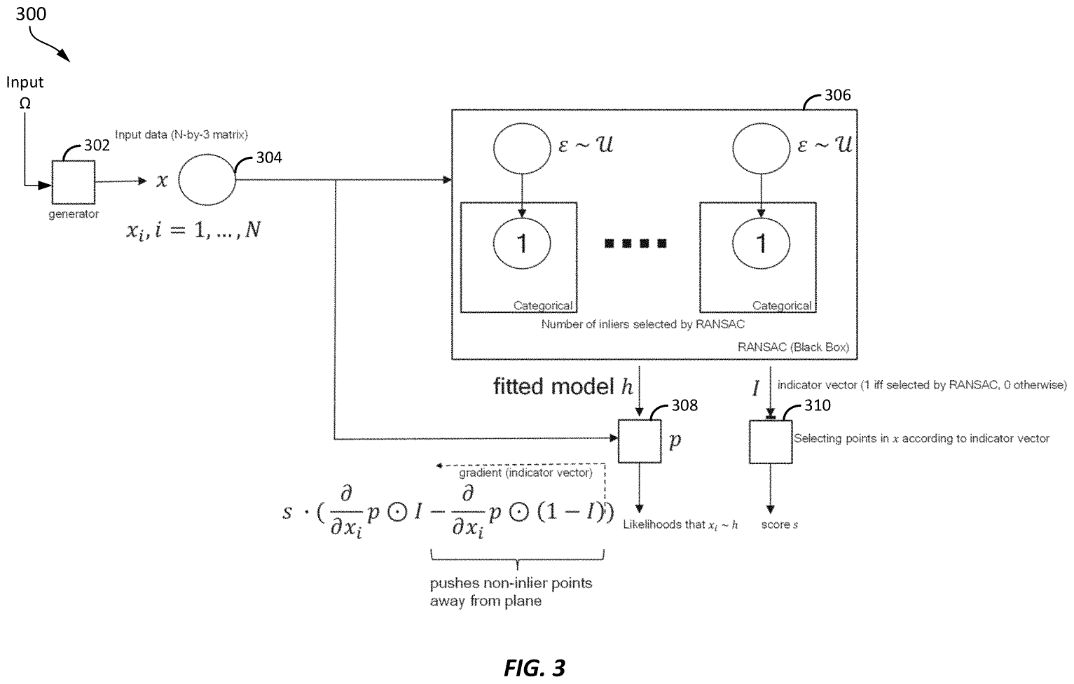

FIG. 3 illustrates an example architecture of a self-supervised location prediction model 300, according to aspects of the present disclosure. As illustrated, the self-supervised location prediction model 300 may include a generator 302 that maps data into points 304 in one or more multidimensional spaces (e.g., a three-dimensional space and a 128-dimensional space). Generally, a highly dimensional space, such as a 128-dimensional space, may be used to allow the generator 302 to extract additional detail from an input than would be generated when an input is mapped to a space with lower dimensionality. For example, for an input of image data, a low-dimensional space may discard more information in the mapping process than a high-dimensional space, and thus, with mappings of inputs in the high-dimensional space, clusters of points in the high-dimensional space may correspond to similar inputs (e.g., images that are visually similar). The points 304 in the multidimensional spaces may be input into a random sample consensus block 306. The random sample consensus block 306 may generate parameters for a model h provided as input to a co-planarity critic model 308 and parameters for an indicator vector provided as input to a granularity critic model 310.

The data provided as an input Ω into the generator 302 may include data from various domains. In some aspects, the data may include panoramic images for a scene generated from a plurality of points along a trajectory through the scene. In some aspects, the data include channel state information (CSI) packages of a plurality of wireless signal measurements performed over time through a given spatial environment.

In some aspects, the generator 302 may be trained to map triplets of data drawn from data Ω into representations of the data located in a multidimensional space. For example, given a state s=[s¹, s², s³], where s^{{1,2,3}} ∈ [symbol] ^{N} drawn from input data Ω, the generator 302 can generate a mapping to points in one or more multidimensional spaces, such as a point in a three-dimensional space and a point in a 128-dimensional space. The data may, for example, include individual images of a scene or channel state information packets. For image data, N may equal 3*width*height (e.g., to represent color channel data in each of the red, green, and blue channels across the width and height of the image).

To train the generator 302, a number of episodes E may be created as unordered sets of random states. Each episode may, for example, include a number of data points from a training data set of scene data representing a multidimensional environment. A vision transformer may be used as the generator 302, and the vision transformer may be trained with two different output heads to generate tuples of outputs, represented according to the equation:

π:|ε|×3N→(|ε|×3·128,|ε|×3·3)

Generally, the generator 302 may map each state to points zₕ ∈ [symbol] ^{3·128} for the height dimension and zₗ ∈ [symbol] ^{3·3} in an ambient three-dimensional space. Generally, the mapping of [symbol] ^{3N}→3·3 may remove information about state information that may be needed by one or both of co-planarity critic model 308 and/or granularity critic model 310.

The co-planarity critic model 308 is generally configured to backpropagate a gradient to cause the generator 302 to attract co-planar data to a given plane and repel non-co-planar data to other planes in a multidimensional space. For a given set of points of an element triple zₗ¹ from an episode ε_{z}_{ₗ}, an objective of the co-planarity critic model 308 may be to maximize the number of points, at the end of episode ε_{z}_{ₗ}, that lie approximately on the same plane in a multidimensional space. At early epochs in training the generator 302, the points in a multidimensional space may resemble a point cloud with randomly distributed points, and a gradient backpropagated to the generator 302 may eventually encourage a planar structure to arise over the epochs through which the generator 302 is trained.

To generate this gradient, a pool of single plane hypotheses [symbol] ={h₁ . . . , h_{|H|}} may be estimated by sampling a number of points from ε_{z}_{ₗ}. Each single-plane hypothesis may be defined according to the equation:

$$p ( h \vert π ) = {\prod }_{i = 1}^{3} p ( {\{ {z}_{l}^{1} \}}_{i} \vert π )$$

where the hypothesis h is generated based on a product of probabilities for each point in an element triple zₗ¹ from an episode ε_{z}_{ₗ}.

A best hypothesis ĥ for the element triples in episode ε_{z}_{ₗ} may be selected as the hypothesis h with the most inliers (e.g., points between an upper bound and a lower bound defined for a plane). A multi-hypothesis set [symbol] ={ĥ₁ . . . , ĥ_{|} [symbol] _{|}} may be generated with a plurality of best hypotheses for randomly sampled points from ε_{z}_{ₗ}, as discussed above. Based on the multi-hypothesis set [symbol] , a set of planes with the most inliers (e.g., points within a threshold distance from a plane, or points that are between an upper bound and a lower bound for the plane) may be selected, according to the equation:

$$p ( ℳ , {ε}_{{z}_{l}} ) = {\prod }_{j = 1}^{\vert ℳ \vert} p ( {\hat{h}}_{j} , {ε}_{{z}_{l}} )$$

Finally, a pool of multi-hypotheses [symbol] ={ [symbol] ₁, . . . , [symbol] } may be generated. From this pool of multi-hypotheses, a multi-hypotheses set [symbol] with a largest number of inliers may be selected, according to the equation:

$$p ( 𝒫 , {ε}_{{z}_{l}} ) = {\prod }_{k = 1}^{\vert 𝒫 \vert} p ( {ℳ}_{j} , {ε}_{{z}_{l}} )$$

This equation may be used to avoid, during gradient decent, a situation in which the algorithm becomes stuck in a local minimum as opposed to a global minimum, or an area in which a gradient descent cannot escape despite the presence of a value within a global feature map having a smaller value than that of the local minimum.

Because point-to-plane distances may be unbounded (e.g., a distance between a point and a plane may not have a known upper bound given a raw data set of inputs), these values may be considered random variables. Thus, the point-plane distances may be represented by the equation:

p({zₗ¹}|ĥ)=exp[−d({zₗ¹}|ĥ)]

A loss signal provided to the generator 302 by the co-planar critic 308 may be computed according to the equation:

l_{c}_{₁}= [symbol] [σ(ĥ)p({zₗ¹}|ĥ)]

where σ(ĥ) represents a score of a hypothesis ĥ and [symbol] refers to the points {zₗ¹} that are in an inner set of each hypothesis ĥ in [symbol] . A gradient may then be given by the equation:

∇l_{c}_{₁}∝ [symbol] [σ(ĥ)∇ log p({zₗ¹}ᵢ|ĥ)]

This function, however, only defines an attraction force that encourages data to converge on a single line. However, points on different frames may need to be actively repelled so they can move further apart for each iteration. Given [symbol] defining the outlier points of hypothesis ĥ, a repulsion force may be introduced into the loss signal discussed above. Thus, the loss signal may be represented by the equation:

∇l_{c}_{₁}∝ [symbol] [σ(ĥ)∇ log p({zₗ¹}ᵢ|ĥ)−β log p({zₗ¹}ᵢ|ĥ, [symbol] )]

where β corresponds to a positive scalar. Applying the repulsion force by the term log p({zₗ¹}ᵢ|ĥ, [symbol] )] may not add to the computational cost of computing this loss, as the gradient vector may be needed for backpropagation, and other critic models may protect against trivial solutions where all points are assigned to a same plane.

The granularity critic model 310 may, in some aspects, be a critic model that enforces granularity among outputs of the generator model 302. Generally, granularity among outputs of the generator model 302 may allow for similar outputs to be generated for similar inputs, such as inputs of scene data captured from different locations that are close to each other. It may be assumed that scene data has a similar appearance when perceived from two positions that are close to each other. Because adjacent inputs may be very similar in appearance (e.g., may have a small delta between them), the outputs generated for these adjacent inputs should not change excessively as well. Based on this observation, the granularity critic model 310 may be designed to encourage samples that are close to each other in an ambient three-dimensional space to be close to each other in an embedding space.

To enforce granularity through the granularity critic model 310, coarse granularity may be enforced among outputs by computing clusterings with different granularities for both high-dimensional outputs and low-dimensional outputs using k-means clustering and multi-scale clusterings.

For example, zₗ¹ may denote a first triplet of the elements of zₗ, and similarly, zₕ¹ may denote a first triplet of the elements of zₕ. A multi-layer perceptron u may map zₗ¹ from [symbol] ³ to [symbol] ⁶⁴. Further, ϕⁱ with i={1, 2, 3} denotes the partitionings of the points zₕ¹, and ψⁱ denote the partitionings of the points u(zₗ¹). The points u(zₗ¹) may be compared in a Siamese style with the clusterings of PCA-projected points zₕ¹, while the PCA-projected points zₕ¹ may be compared with the clusterings of the points u(zₗ¹).

A loss signal provided by the granularity critic model 310 may thus be formulated according to the equation:

$${l}_{{c}_{2}} = {\sum }_{i = 1}^{3} {l}_{ce} ( {z}_{l}^{1} , {ϕ}^{i} ( {z}_{h}^{1} ) ) + {l}_{ce} ( {z}_{h}^{1} , {ψ}^{i} ( u ( {z}_{l}^{1} ) ) )$$

where l_{ce} represents a cross-entropy loss. The outputs of the generator zₗ¹ and zₕ¹ may be in the same clusters as the samples clustered by the k-means clusters. Generally, stability may be promoted when cluster assigns are computed at the beginning of each epoch.

Another critic model (not illustrated) may include a model based on scene flow constraints, which generally defines changes in terms of temporal relationships. For a set of time-series data, such as a series of images, scene flow constraints may dictate that two images in the series of images that are closer in time are more similar than two images that are further away in time. To implement a critic model based on scene flow constraints, let χ be a set of three-dimensional points on surfaces within a scene, [symbol] (t) represent an extrinsic component of camera motion at time t, and E(χ) denote lighting and photometric properties of the scene. The state of the scene may be represented by the equation S(t)=S(χ, E, [symbol] (t)), and a projection of the scene S may be represented by the equation:

I(t)=Π[S(t),C(t)]

where C(t) represents the properties of the camera that captured the scene S.

Scene flow, or the rate at which a scene changes over time, may be represented by a temporal derivative, ∂S/∂t, and optical flow, or the rate at which the brightness of components within a scene change over time, may be represented by the temporal derivative, ∂l/∂t. Both scene flow and optical flow may allow for the estimation of dense depth within a spatial environment; however, the estimation of either scene flow or optical flow may be a computationally complex task that may entail inference on sparse or dense correspondence between image pairs. The task may be relaxed by defining the function:

ƒ[I(t)]≈Π⁻¹[S(t),C(t)]i(t)=S(t).

Thus, by relaxing the task, the following equation may be derived for scene flow:

$$\frac{\partial S}{\partial t} \approx \frac{\partial f}{\partial t}$$

Scene flow may generally increase with temporal offsets, such that a scene flow between time instances tᵢ and tⱼ is smaller than the scene flow between tᵢ and tₖ for distinct t_{(i, j, k)} if tᵢ and tₖ are temporally further apart than tᵢ and tⱼ. This may be the case because there may be small differences between images captured close to each other temporally, and the differences between images captured at two different times may generally increase as the amount of time elapsed between these images increases. To use a simple example, in a scene in which an object is moving from left to right, the distance between the location of the object at an initial frame and any given subsequent frame generally increases as the amount of time increases. Effectively, thus, the rate of change of the scene flow may be constrained according to the equation:

$$\frac{{\partial }^{2}}{{\partial }^{2} t} f \geq τ ,$$

where τ is a positive scalar that prevents a trivial solution.

Generally, it may be assumed that E(χ) does not vary significantly for small temporal changes because it may be assumed that the amount of change in frames separated by small amounts of time may be minimal. Thus, the scene flow for an input set of scene data may largely depend on camera motion. Because the generator network π generally infers camera location from images, ƒ may be associated with π. To account for changes in scene flow at intersections in trajectories or re-visitations of similar locations in the scene data, the rate of change for the scene flow may be formulated probabilistically by randomly drawing t_{(i, j, k)} subject to the constraints discussed above. A resulting component may be interchangeable with and similar to a triple margin loss, and can be optimized by selecting the triplets s^{{1, 2, 3}} under the constraints imposed for selecting t_{(i, j, k)}.

### Example Identification of Points on Planes Using Models for Predicting Device Location on Planes in a Spatial Environment

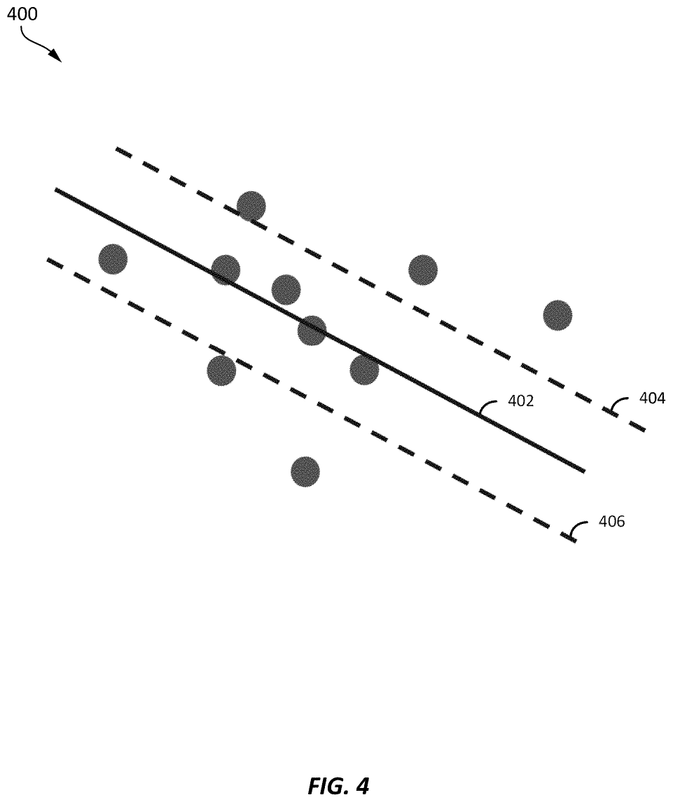

FIG. 4 illustrates an example 400 of an inlier threshold for identifying points on a plane in a multidimensional space based on point density, according to aspects of the present disclosure.

As illustrated, a plane 402 and inlier thresholds 404 and 406 may be selected based on a line search. Generally, a line search for the plane 402 may result in a line that passes through a plurality of points on a plane in the multidimensional space. The thresholds 404, 406 may be selected by walking out from the plane 402 to identify a line in which no points lie on the line. Based on this inlier, the generator model may be configured with a loss function (described above) to attract points between the inlier thresholds 404 and 406 to the plane 402 and repel points outside of the inlier thresholds 404 and 406 to other planes in a multidimensional space.

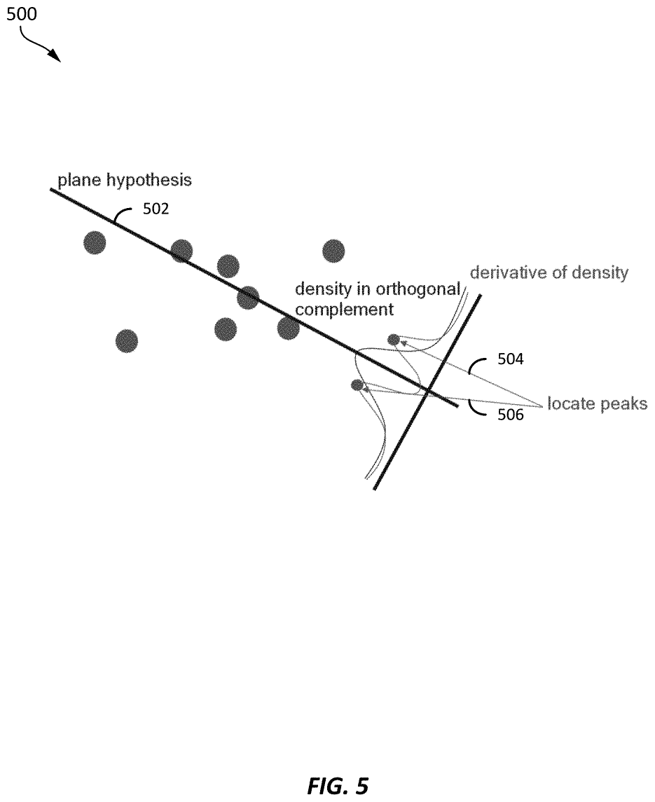

FIG. 5 illustrates an example 500 of an inlier threshold for identifying points on a plane in a multidimensional space based on point density, according to aspects of the present disclosure.

In example 500, the density of the points in the multidimensional space may be represented by an orthogonal complement, and the maximum point of the orthogonal complement may correspond to a hypothesized plane to which adjacent points will be attracted and from which points outside of a set of outliers will be repelled. To identify the inlier thresholds, a derivative of the density function may be calculated. The peaks 504 and 506 of the derivative function may, for example, indicate the location of the inlier thresholds to be used in attracting points to the plane 502 and repel points outside of the inlier thresholds defined by the peaks 504 and 506.

In FIGS. 4 and 5, the decision of whether a point falls on a given plane, and thus the selection of the appropriate inlier thresholds for defining whether a point falls on that given plane, may be performed by the self-supervised location prediction models discussed herein based on the critic models that maximize co-planarity of points within a data set. As discussed, co-planarity may be an appropriate presumption for many spatial environments, as most motion within a spatial environment may be performed on a specific plane, and a significantly smaller amount of motion within the spatial environment may be performed between planes in the spatial environment. For example, in a multi-story building, it may be assumed that most motion occurs on a floor in the multi-story building, and that a significantly smaller amount of motion occurs while moving from one floor to another floor in the spatial environment. The selection of the inlier points thus may seek to maximize the number of points that are assumed to be located on any specific plane (e.g., floor of a building) while minimizing the risk of misclassifying a point as being associated with a different plane in the multi-story building.

### Example Operations for Training and Using Models for Predicting Device Location on Planes in a Spatial Environment

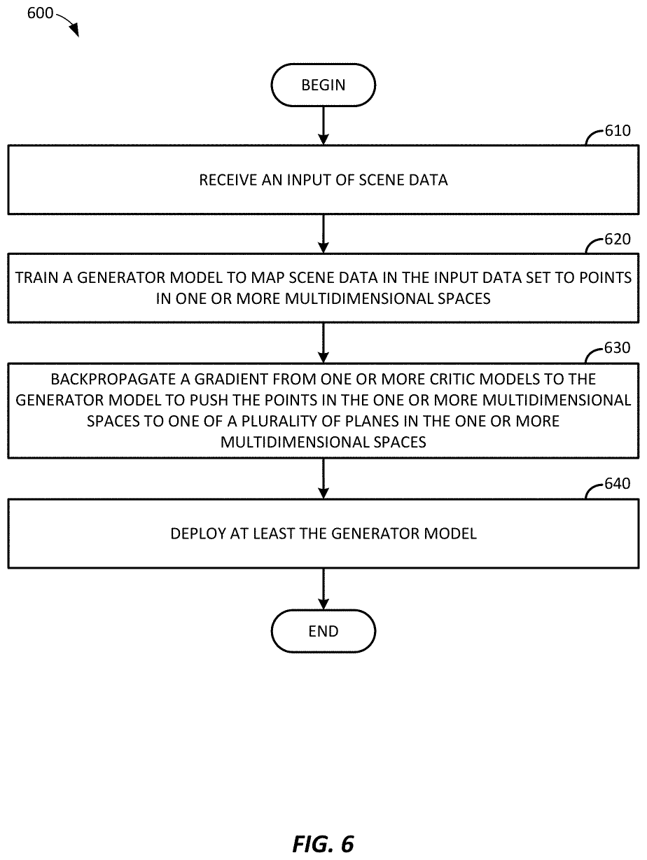

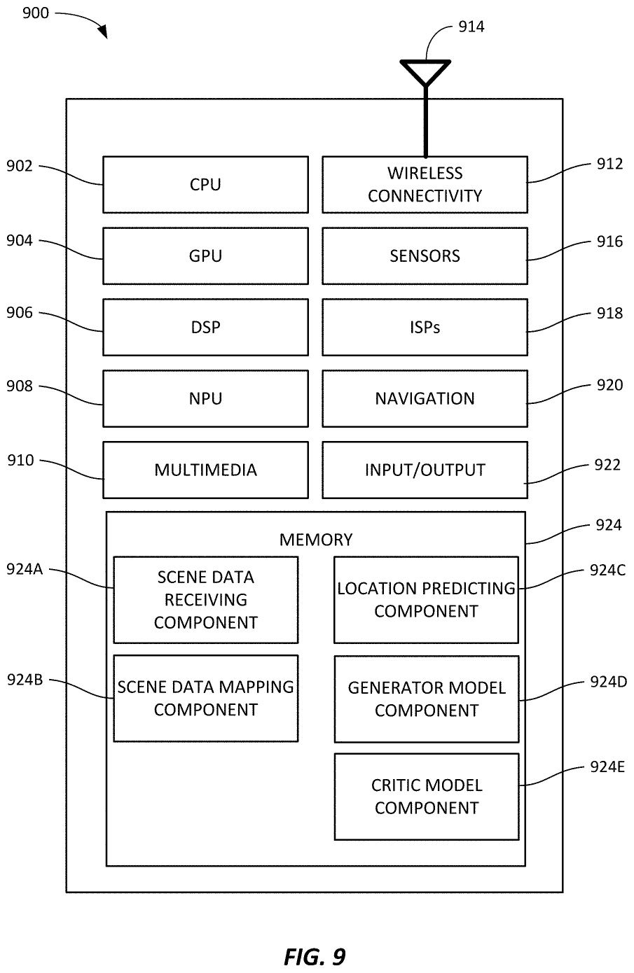

FIG. 6 illustrates example operations 600 for training a self-supervised location prediction model to predict a location of a device on one of a plurality of planes in a multidimensional space, according to aspects of the present disclosure. Operations 600 may be performed, for example, by a computing device that can train the machine learning model and deploy the machine learning model to another device for use in location prediction in a spatial environment. For example, the computing device may be configured to deploy the machine learning model to a user equipment or a system 900 illustrated in FIG. 9 and described in further detail below.

As illustrated, operations 600 begin at block 610, where an input data set of scene data is received. The input data set of scene data may, in some aspects, include one or more images of a spatial environment. These images may include, for example, captured panoramic images in the visible spectrum of a space for which location prediction is to be performed, generated panoramic images for a virtual space, or the like. In some aspects, the input data set of scene data may include power density maps associated with channel state information (CSI) measurements over time. These power density maps may show, for example, changes in power density as objects move within a three-dimensional environment.

At block 620, a generator model is trained. The generator model, such as the generator 302 illustrated in FIG. 3, may be trained to map scene data in the input data set to points in one or more multidimensional spaces. For example, the generator model may be trained based on a plurality of episodes of random states drawn from the scene data in the input data set to map each state to a point in one or more multidimensional spaces. The generator model may be represented, for example, according to the equation:

π:|ε|×3N→(|ε|×3·128,|ε|×3·3)

As discussed, when the generator model is initially trained, the generator model may be trained to map data in the input data set to varying points in a cloud of points in one or more multidimensional embedding spaces, such as a first three-dimensional space and a second 128-dimensional space. Loss functions, or gradients, backpropagated to the generator model by one or more critic models (e.g., the co-planarity critic model 308 and/or granularity critic model 310 illustrated in FIG. 3), as discussed above, may train the generator model to map inputs to one of a plurality of planes in the one or more multidimensional spaces.

In some aspects, the loss functions may include loss functions that encourage co-planarity of points in a multidimensional space, loss functions that encourage granularity in the multidimensional space such that similar inputs (e.g., scene data captured close to each other spatially) result in mappings to similar points in the multidimensional space, and the like. A co-planarity loss function may be represented by the equation:

∇l_{c}_{₁}∝ [symbol] [σ(ĥ)∇ log p({zₗ¹}ᵢ|ĥ)−β log p({zₗ¹}ᵢ|ĥ, [symbol] )]

The preceding equation includes a first term, log p({zₗ¹}ᵢ|ĥ), that attracts points located on a same plane and a second term, β log p({zₗ¹}ᵢ|ĥ, [symbol] ), that repels points located on different planes.

A granularity loss function may be represented by the equation:

$${l}_{{c}_{2}} = {\sum }_{i = 1}^{3} {l}_{ce} ( {z}_{l}^{1} , {ϕ}^{i} ( {z}_{h}^{1} ) ) + {l}_{ce} ( {z}_{h}^{1} , {ψ}^{i} ( u ( {z}_{l}^{1} ) ) )$$

As discussed above, this granularity loss function generally uses cross-entropy loss between different inputs to minimize granularity loss. Generally, to minimize granularity loss, the outputs of a generator may be included in the same clusters as the clusters of scene data (e.g., generated using k-means clustering, as discussed above).

Further loss functions may include, for example, scene flow-based loss functions, as discussed above. These scene flow-based loss functions may encourage the generator model to learn plausible reconstructions of data, such as spatial environments with multiple planes (e.g., floors in a building, components in a built environment with different heights, etc.). The scene flow-based loss functions may constrain a rate of change over time, based on the notion that differences in scenes increase as the time between capturing these scenes increases.

At block 630, one or more critic models backpropagate a gradient to the generator model. As discussed, the gradient may train the generator model to push points in the one or more multidimensional spaces to one of a plurality of planes in the one or more multidimensional spaces.

In some aspects, the one or more critic models may include a first critic model configured to promote co-planarity of points in the one or more multidimensional spaces generated by the generator model and a second critic model configured to enforce granularity among outputs of the generator model. The first critic model may be configured to select a best hypothesis of a plane in the one or more multidimensional spaces based on a number of inliers along each plane in the one or more multidimensional spaces for an input of scene data. In some aspects, the first critic model can generate an attraction force and a repulsion force to apply to mapped data in the one or more multidimensional spaces. The attraction force can be used to attract points within an inlier threshold to a plane, such as those illustrated in FIGS. 4 and 5, in the one or more multidimensional spaces and repel points outside of the inlier threshold to other planes in the one or more multidimensional spaces. The second critic model may be configured to minimize a loss between adjacent clusters in a spatial environment so that the outputs of a generator model are similar for spatially similar inputs of scene data (e.g., images captured by cameras located adjacent to each other).

In some aspects, the generator model and the one or more critic models may be further trained based on a scene flow constraint term. The scene flow constraint term may increase in value with a temporal offset from an initial point in time, representing the notion that changes in scene data between two frames that are close in time are less drastic than changes in scene data between two frames that are more distant in time.

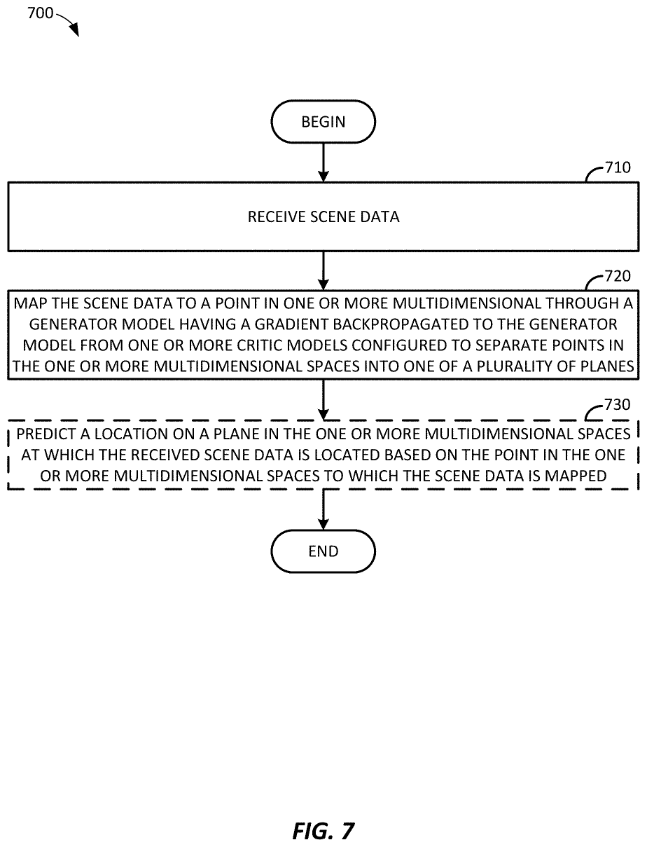

FIG. 7 illustrates example operations 700 for predicting a location of a device or person on one of a plurality of planes in one or more multidimensional spaces using a self-supervised location prediction model, according to aspects of the present disclosure. Operations 700 may be performed, for example, by a user equipment (UE) or a system 900 illustrated in FIG. 9.

As illustrated, operations 700 begin at block 710, where scene data is received. The scene data may, in some aspects, include one or more images of a spatial environment. These images may include, for example, captured panoramic images in the visible spectrum of a space for which location prediction is to be performed, generated panoramic images for a virtual space, or the like. In some aspects, the scene data may include power density maps associated with channel state information (CSI) measurements over time. These power density maps may show, for example, changes in power density as objects move within a three-dimensional spatial environment.

At block 720, the scene data may be mapped to a point in one or more multidimensional spaces through a generator model (e.g., the generator model 302 illustrated in FIG. 3) having a loss term backpropagated to the generator model from one or more critic models (e.g., the co-planarity critic model 308 and/or granularity critic model 310 illustrated in FIG. 3) configured to separate points in the one or more multidimensional spaces into one of a plurality of planes. The gradient, in some aspects, may include an attraction force term that pushes co-planar points in the one or more multidimensional spaces towards the same plane and a repulsion force that pushes points located on different planes in the one or more multidimensional spaces away from each other, according to the equation:

∇l_{c}_{₁}∝ [symbol] [σ(ĥ)∇ log p({zₗ¹}ᵢ|ĥ)−β log p({zₗ¹}ᵢ|ĥ, [symbol] )]

The gradient may, for example, include a minimized loss between adjacent clusters in a spatial environment, represented by the equation:

l_{c}_{₂}=Σᵢ₌₁³l_{ce}(zₗ¹,ϕⁱ(zₕ¹))+l_{ce}(zₕ¹,ψⁱ(u(zₗ¹)))

The preceding equation enforces similarity of outputs generated by the generator model inputs that are adjacent to each other in a three-dimensional spatial environment. In some aspects, the gradient may include a scene flow constraint term that increases in value with a temporal offset from an initial point in time, which may be used to enforce temporal similarity from the notion that images captured at points in time that are close to each other may be more similar than images captured at points in time that are further from each other.

In some aspects, operations 700 may proceed to block 730, where the location on a plane in the one or more multidimensional spaces at which the received scene data is located is predicted based on the point in the one or more multidimensional spaces to which the scene data is mapped. As discussed, the generator model may be configured to map inputs to one of a plurality of planes in one or more multidimensional spaces, with each plane in the one or more multidimensional spaces corresponding to one of a plurality of floors or other spatial areas with a height component. The predicted location on the plane in the one or more multidimensional spaces may include a location on the plane and an identification of which plane of a plurality of planes on which the received scene data is located.

### Example Processing Systems for Predicting Device Location on Planes in a Spatial Environment Using Self-Supervised Machine Learning Models

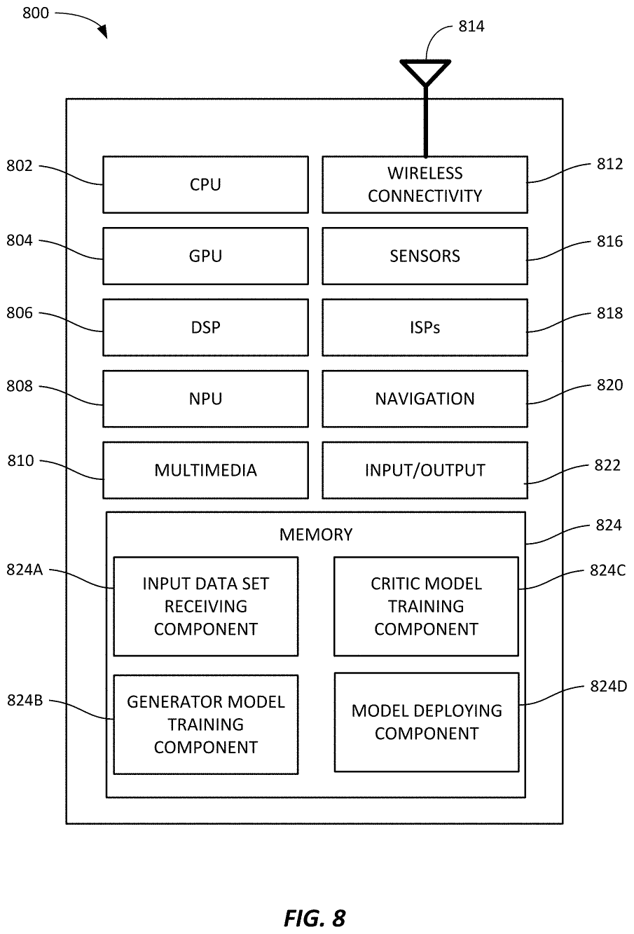

FIG. 8 depicts an example processing system 800 for training a machine learning models to predict a location of a device and a location of one or more virtual anchors in a spatial environment, such as described herein for example with respect to FIG. 6.

The processing system 800 includes a central processing unit (CPU) 802, which in some examples may be a multi-core CPU. Instructions executed at the CPU 802 may be loaded, for example, from a program memory associated with the CPU 802 or may be loaded from a memory 824.

The processing system 800 also includes additional processing components tailored to specific functions, such as a graphics processing unit (GPU) 804, a digital signal processor (DSP) 806, a neural processing unit (NPU) 808, a multimedia processing unit 810, a wireless connectivity component 812.

An NPU, such as NPU 808, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. The wireless connectivity component 812 is further connected to one or more antennas 814.

In some examples, one or more of the processors of the processing system 800 may be based on an ARM or RISC-V instruction set.

The processing system 800 also includes the memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes an input data set receiving component 824A, a generator model training component 824B, a critic model training component 824C, and a model deploying component 824D. The depicted components, and others not depicted, may be configured to perform various aspects of the methods described herein.

Generally, the processing system 800 and/or components thereof may be configured to perform the methods described herein.

Notably, in other embodiments, aspects of the processing system 800 may be omitted, such as where the processing system 800 is a server computer or the like. For example, the multimedia component 810, the wireless connectivity component 812, the sensors 816, the ISPs 818, and/or the navigation component 820 may be omitted in other embodiments. Further, aspects of the processing system 800 may be distributed, such as training a model and using the model to generate inferences.

FIG. 9 depicts an example processing system 900 for predicting a location of a device or person on one of a plurality of planes in one or more multidimensional spaces using a machine learning model, such as described herein for example with respect to FIG. 7.

The processing system 900 includes a central processing unit (CPU) 902, which in some examples may be a multi-core CPU. The processing system 900 also includes additional processing components tailored to specific functions, such as a graphics processing unit (GPU) 904, a digital signal processor (DSP) 906, and a neural processing unit (NPU) 908. The CPU 902, GPU 904, DSP 906, and NPU 908 may be similar to the CPU 802, GPU 804, DSP 806, and NPU 808 discussed above with respect to FIG. 8.

In some examples, the wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. The wireless connectivity component 912 may be further connected to one or more antennas (not shown).

In some examples, one or more of the processors of the processing system 900 may be based on an ARM or RISC-V instruction set.

The processing system 900 also includes a memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

In particular, in this example, the memory 924 includes a scene data receiving component 924A, a scene data mapping component 924B, a location predicting component 924C, a generator model component 924D (such as generator model 302 described above with respect to FIG. 3), and a critic model component 924E (such as co-planarity critic model 308 and/or granularity critic model 310 described above with respect to FIG. 3). The depicted components, and others not depicted, may be configured to perform various aspects of the methods described herein.

Generally, the processing system 900 and/or components thereof may be configured to perform the methods described herein.

Notably, in other embodiments, aspects of the processing system 900 may be omitted, such as where the processing system 900 is a server computer or the like. For example, the multimedia component 910, the wireless connectivity component 912, the sensors 916, the ISPs 918, and/or the navigation component 920 may be omitted in other embodiments.

### Example Clauses

Implementation details of various aspects of the present disclosure are described in the following numbered clauses.

Clause 1: A method, comprising: receiving an input data set of scene data; training a generator model to map scene data in the input data set to points in one or more multidimensional spaces; backpropagating a gradient from one or more critic models to the generator model to push the points in the one or more multidimensional spaces to one of a plurality of planes in the one or more multidimensional spaces; and deploying the generator model and one or more critic models.

Clause 2: The method of Clause 1, wherein the scene data comprises one or more images of a spatial environment.

Clause 3: The method of any one of Clauses 1 or 2, wherein the scene data comprises a power density map associated with channel state information (CSI) measurements obtained over time.

Clause 4: The method of any one of Clauses 1 through 3, wherein the one or more critic models comprise a first critic model configured to promote co-planarity of points in the one or more multidimensional spaces generated by the generator model and a second critic model configured to enforce granularity among outputs of the generator model.

Clause 5: The method of Clause 4, wherein the first critic model is trained to select a best hypothesis of a plane in the one or more multidimensional spaces based on a number of inliers along each plane in the one or more multidimensional spaces for an input of scene data.

Clause 6: The method of any one of Clauses 4 or 5, wherein the first critic model generates an attraction force and a repulsion force to apply to mapped data in the one or more multidimensional spaces.

Clause 7: The method of any one of Clauses 4 through 6, wherein the second critic model is configured to minimize a loss between adjacent clusters in a spatial environment.

Clause 8: The method of any one of Clauses 1 through 7, further comprising training the generator model and the one or more critic models based on a scene flow constraint term that increases in value with a temporal offset from an initial point in time.

Clause 9: The method of any one of Clauses 1 through 8, wherein the one or more multidimensional spaces comprises a three-dimensional space and a 128-dimensional space.

Clause 10: A method, comprising: receiving scene data; and mapping the scene data to a point in one or more multidimensional spaces through a generator model having a gradient backpropagated to the generator model from one or more critic models configured to separate points in the one or more multidimensional spaces into one of a plurality of planes.

Clause 11: The method of Clause 10, further comprising predicting a location on a plane in the one or more multidimensional spaces at which the received scene data is located based on the point in the three-dimensional space to which the scene data is mapped.

Clause 12: The method of any one of Clauses 10 or 11, wherein the scene data comprises one or more images of a spatial environment.

Clause 13: The method of any one of Clauses 10 through 12, wherein the scene data comprises a power density map associated with channel state information (CSI) measurements obtained over time.

Clause 14: The method of any one of Clauses 10 through 13, wherein the gradient comprises an attraction force term that pushes co-planar points in the three-dimensional space onto a same plane and a repulsion force that pushes points located on different planes in the three-dimensional space away from each other.

Clause 15: The method of any one of Clauses 10 through 14, wherein the gradient comprises a minimized loss between adjacent clusters in a spatial environment.

Clause 16: The method of any one of Clauses 10 through 15, wherein the gradient comprises a scene flow constraint term that increases in value with a temporal offset from an initial point in time.

Clause 17: The method of any one of Clauses 10 through 16, wherein the one or more multidimensional spaces comprises a three-dimensional space and a 128-dimensional space.

Clause 18: A processing system, comprising: a memory comprising computer-executable instructions; one or more processors configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for training a machine learning model for predicting a location of an object in a multi-planar spatial environment, comprising:
receiving an input data set of scene data;
training a generator model to map scene data in the input data set to points in one or more multidimensional spaces;
backpropagating a gradient from one or more critic models to the generator model to push the points in the one or more multidimensional spaces to one of a plurality of planes in the one or more multidimensional spaces; and
deploying at least the generator model.

2. The method of claim 1, wherein the scene data comprises one or more images of a spatial environment.

3. The method of claim 1, wherein the scene data comprises a power density map associated with channel state information (CSI) measurements obtained over time.

4. The method of claim 1, wherein the one or more critic models comprise a first critic model configured to promote co-planarity of points in the one or more multidimensional spaces generated by the generator model and a second critic model configured to enforce granularity among outputs of the generator model.

5. The method of claim 4, wherein the first critic model is configured to select a best hypothesis of a plane in the one or more multidimensional spaces based on a number of inliers along each plane in the one or more multidimensional spaces for an input of scene data.

6. The method of claim 4, wherein the first critic model generates an attraction force and a repulsion force to apply to mapped data in the one or more multidimensional spaces.

7. The method of claim 4, wherein the second critic model is configured to minimize a loss between adjacent clusters in a spatial environment.

8. The method of claim 1, further comprising training the generator model and the one or more critic models based on a scene flow constraint term that increases in value with a temporal offset from an initial point in time.

9. The method of claim 1, wherein the one or more multidimensional spaces comprises a three-dimensional space and a 128-dimensional space.

10. A computer-implemented method for predicting a location of an object in a multi-planar spatial environment, comprising:
receiving scene data; and
mapping the scene data to a point in one or more multidimensional spaces through a generator model having a gradient backpropagated to the generator model from one or more critic models configured to separate points in the one or more multidimensional spaces into one of a plurality of planes such that the points in the one or more multidimensional spaces are in a vicinity of any of the plurality of planes in the one or more multidimensional spaces.

11. The method of claim 10, further comprising predicting a location on a plane in the one or more multidimensional spaces at which the received scene data is located based on the point in the one or more multidimensional spaces to which the scene data is mapped.

12. The method of claim 10, wherein the scene data comprises one or more images of a spatial environment.

13. The method of claim 10, wherein the scene data comprises a power density map associated with channel state information (CSI) measurements obtained over time.

14. The method of claim 10, wherein the gradient comprises an attraction force term that pushes co-planar points in the one or more multidimensional spaces onto a same plane and a repulsion force that pushes points located on different planes in the one or more multidimensional spaces away from each other.

15. The method of claim 10, wherein the gradient comprises a minimized loss between adjacent clusters in a spatial environment.

16. The method of claim 10, wherein the gradient comprises a scene flow constraint term that increases in value with a temporal offset from an initial point in time.

17. The method of claim 10, wherein the one or more multidimensional spaces comprise a three-dimensional space and a 128-dimensional space.

18. A processing system, comprising:
a memory having executable instructions stored thereon; and
a processor configured to execute the executable instructions to cause the processing system to:
receive an input data set of scene data;
train a generator model to map scene data in the input data set to points in one or more multidimensional spaces;
backpropagate a gradient from one or more critic models to the generator model to push the points in the one or more multidimensional spaces to one of a plurality of planes in the one or more multidimensional spaces; and
deploy at least the generator model.

19. The processing system of claim 18, wherein the one or more critic models comprise a first critic model configured to promote co-planarity of points in the one or more multidimensional spaces generated by the generator model and a second critic model configured to enforce granularity among outputs of the generator model.

20. The processing system of claim 19, wherein the first critic model is configured to select a best hypothesis of a plane in the one or more multidimensional spaces based on a number of inliers along each plane in the one or more multidimensional spaces for an input of scene data.

21. The processing system of claim 19, wherein the second critic model is configured to minimize a loss between adjacent clusters in a spatial environment.

22. The processing system of claim 18, wherein the processor is further configured to cause the processing system to train the generator model and the one or more critic models based on a scene flow constraint term that increases in value with a temporal offset from an initial point in time.

23. A processing system, comprising:
a memory having executable instructions stored thereon; and
a processor configured to execute the executable instructions to cause the processing system to:
receive scene data; and
map the scene data to a point in one or more multidimensional spaces through a generator model having a gradient backpropagated to the generator model from one or more critic models configured to separate points in the one or more multidimensional spaces into one of a plurality of planes such that the points in the one or more multidimensional spaces are in a vicinity of any of the plurality of planes in the one or more multidimensional spaces.

24. The processing system of claim 23, wherein the processor is further configured to cause the processing system to predict a location on a plane in the one or more multidimensional spaces at which the received scene data is located based on the point in the one or more multidimensional spaces to which the scene data is mapped.

25. The processing system of claim 23, wherein the scene data comprises one or more images of a spatial environment.

26. The processing system of claim 23, wherein the scene data comprises a power density map associated with channel state information (CSI) measurements obtained over time.

27. The processing system of claim 23, wherein the gradient comprises an attraction force term that pushes co-planar points in the one or more multidimensional spaces onto a same plane and a repulsion force that pushes points located on different planes in the one or more multidimensional spaces away from each other.

28. The processing system of claim 23, wherein the gradient comprises a minimized loss between adjacent clusters in a spatial environment.

29. The processing system of claim 23, wherein the gradient comprises a scene flow constraint term that increases in value with a temporal offset from an initial point in time.

30. The processing system of claim 23, wherein the one or more multidimensional spaces comprise a three-dimensional space and a 128-dimensional space.
